(19) United States
(12) Patent Application Publication
(10) Pub. No.: US 2025/0271617 A1
(43) Pub. Date: Aug. 28, 2025

(54) RING RESONATOR AND ITS MANUFACTURING METHOD

(71) Applicant: NEC Corporation, Tokyo (JP)

(72) Inventor: Ryo MARUYAMA, Tokyo (JP)

(73) Assignee: NEC Corporation, Tokyo (JP)

(21) Appl. No.: 19/050,277

(22) Filed: Feb. 11, 2025

(30) Foreign Application Priority Data
Feb. 22, 2024 (JP) 2024-025797

(51) Int. Cl. G02B 6/293

(52) U.S. Cl. CPC G02B 6/29338

(57) ABSTRACT

A ring resonator includes an input waveguide, a first ring waveguide, a second ring waveguide, an output waveguide, and a heater. The first ring waveguide includes a first waveguide part optically connected to the input waveguide, and a third waveguide part which is a longer one of two waveguide parts connecting the first waveguide part to a second waveguide part optically connected to the second ring waveguide. The second ring waveguide includes a fourth waveguide part optically connected to the second waveguide part, and a sixth waveguide part which is a longer one of two waveguide parts connecting the fourth waveguide part to a fifth waveguide part optically connected to the output waveguide. The heater extends along the third and six waveguide parts.

### INCORPORATION BY REFERENCE

This application is based upon and claims the benefit of priority from Japanese patent application No. 2024-025797, filed on Feb. 22, 2024, the disclosure of which is incorporated herein in its entirety by reference.

### TECHNICAL FIELD

The present disclosure relates to a ring resonator and its manufacturing method.

### BACKGROUND ART

Patent Literature 1 discloses a technology for realizing an optical wavelength-variable filter by disposing a heater on a double micro-ring waveguide.

Patent Literature 1: Japanese Patent No. 6434864

### SUMMARY

When a heater is disposed near a coupling region of two ring waveguides, the two ring waveguides thermally interfere with each other. Although the thermal interference can be suppressed by reducing the length of the heater disposed along the ring waveguides, there is a problem that the lengths of the parts of the waveguides that are heated are reduced.

The present disclosure has been made in order to solve the above-described problem, and an object thereof is to provide a ring resonator in which thermal interference is prevented from occurring while the length of a part of a waveguide that is heated is secured, and to provide a method for manufacturing such a ring resonator.

A ring resonator according to the present disclosure includes:
an input waveguide;
a first ring waveguide;
a second ring waveguide;
an output waveguide; and
a heater, in which
the first ring waveguide includes a first waveguide part optically connected to the input waveguide, a second waveguide part optically connected to the second ring waveguide, and two curved waveguide parts each connecting the first and second waveguide parts to each other,
lengths of the two waveguide parts of the first ring waveguide are different from each other,
the second ring waveguide includes a fourth waveguide part optically connected to the second waveguide part, a fifth waveguide part optically connected to the output waveguide, and two curved waveguide parts each connecting the fourth and fifth waveguide parts to each other,
lengths of the two waveguide parts of the second ring waveguide are different from each other,
the first and fifth waveguide parts are arranged on sides opposite to each other with respect to a center line passing through the first and second ring waveguides, a first direction along the first and fifth waveguide parts and a second direction along the second and fourth waveguide parts are not parallel to each other, and
the heater is disposed along each of a third waveguide part and a sixth waveguide part, the third waveguide part being a longer one of the two waveguide parts of the first ring waveguide, and the sixth waveguide part being a longer one of the two waveguide parts of the second ring waveguide.

A method for manufacturing a ring resonator according to the present disclosure includes:
forming an input waveguide, a first ring waveguide, a second ring waveguide, and an output waveguide; and
forming a heater, in which
the first ring waveguide includes a first waveguide part optically connected to the input waveguide, a second waveguide part optically connected to the second ring waveguide, and two curved waveguide parts each connecting the first and second waveguide parts to each other,
lengths of the two waveguide parts of the first ring waveguide are different from each other,
the second ring waveguide includes a fourth waveguide part optically connected to the second waveguide part, a fifth waveguide part optically connected to the output waveguide, and two curved waveguide parts each connecting the fourth and fifth waveguide parts to each other,
lengths of the two waveguide parts of the second ring waveguide are different from each other,
the first and fifth waveguide parts are arranged on sides opposite to each other with respect to a center line passing through the first and second ring waveguides, a first direction along the first and fifth waveguide parts and a second direction along the second and fourth waveguide parts are not parallel to each other, and
the heater is disposed along each of a third waveguide part and a sixth waveguide part, the third waveguide part being a longer one of the two waveguide parts of the first ring waveguide, and the sixth waveguide part being a longer one of the two waveguide parts of the second ring waveguide.

According to the present disclosure, it is possible to provide a ring resonator in which thermal interference is prevented from occurring while the length of a part of a waveguide that is heated is secured, and to provide a method for manufacturing such a ring resonator.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a schematic plan view of a ring resonator according to a reference example;

FIG. 2 is a schematic plan view of a ring resonator according to the present disclosure;

FIG. 3 is a schematic cross-sectional view of the ring resonator according to the present disclosure;

FIG. 4 is a schematic cross-sectional view of the ring resonator according to the present disclosure;

FIG. 5 is a schematic plan view of a ring resonator according to the present disclosure; and

FIG. 6 is a flowchart showing a method for manufacturing a ring resonator according to the present disclosure.

### EXAMPLE EMBODIMENT

Study that has LED to Example Embodiment

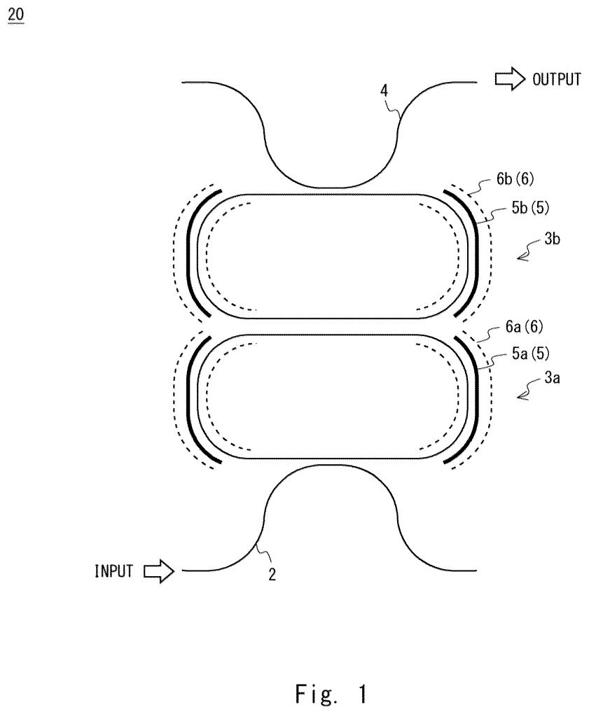

A configuration of a ring resonator 20 according to a reference example will be described hereinafter with reference to FIG. 1. FIG. 1 is a schematic plan view of the ring resonator 20. The ring resonator 20 includes an input waveguide 2, a ring waveguide 3a, a ring waveguide 3b, an output waveguide 4, a heater 5, and a thermal insulation structure 6.

When the ring waveguides 3a and 3b are not distinguished from each other, they may be simply referred to as the ring waveguides 3. Each of the ring waveguides 3a and 3b has a racetrack shape. The racetrack shape consists of two parallel lines having lengths equal to each other and two curves connecting the two parallel lines to each other. The parts of the ring waveguides 3 corresponding to the parallel lines are also referred to as straight parts, and the parts corresponding to the curves are also referred to as semicircular parts.

The input waveguide 2 is optically connected to one of the straight parts of the ring waveguide 3a (e.g., the lower straight part in the drawing). Light is input from one end of the input waveguide 2 (e.g., the left end in the drawing). A part of the input light propagates to the ring waveguide 3a.

Light that has propagated to the ring waveguide 3a circulates, i.e., propagates in a circular shape, along the ring waveguide 3a in one direction (e.g., the counterclockwise direction in the drawing). The other straight part of the ring waveguide 3a (e.g., the upper straight part in the drawing) is optically connected to one of the straight parts of the ring waveguide 3b (e.g., the lower straight part in the drawing). Light, i.e., a part of the light, having a wavelength equal to the resonant wavelength of the ring waveguide 3a propagates to the ring waveguide 3b.

Light that has propagated to the ring waveguide 3b circulates, i.e., propagates in a circular shape, along the ring waveguide 3b in one direction (e.g., the clockwise direction in the drawing). The other straight part of the ring waveguide 3b (e.g., the upper straight part in the drawing) is optically connected to the output waveguide 4. Light, i.e., a part of the light, having a wavelength equal to the resonant wavelength of the ring waveguide 3b propagates to the output waveguide 4. The resonant wavelengths of the ring waveguides 3a and 3b may be equal to each other.

The output waveguide 4 outputs light from one end thereof (e.g., the right end in the drawing).

The heater 5 and the thermal insulation structure 6 are arranged along the ring waveguides 3a and 3b. The heater 5 and the thermal insulation structure 6 arranged along the ring waveguide 3a are also referred to as a heater 5a and a thermal insulation structure 6a, respectively. The heater 5 and the thermal insulation structure 6 arranged along the ring waveguide 3b are also referred to as a heater 5b and a thermal insulation structure 6b, respectively. As shown in the drawing, the heater 5 and the thermal insulation structure 6 may be arranged along the semicircular parts of the ring waveguides 3a and 3b.

The thermal insulation structure 6 is, for example, an air layer or a vacuum layer disposed below the ring waveguide 3 and the heater 5. By arranging the heater 5 and the thermal insulation structure 6, the electric power input to the heater 5 is reduced.

A case where the heater 5 and the thermal insulation structure 6 are arranged along the entire circumferences of the ring waveguides 3a and 3b will be described. The thermal insulation structures 6a and 6b are close to each other in regions where the ring waveguides 3a and 3b are optically connected to each other (also referred to as a coupling region). As a result, there is a problem that the mechanical strength of the ring resonator 20 is poor. Similarly, since the heaters 5a and 5b are close to each other in the above-described coupling region, when one of the ring waveguides is heated, it causes an unintended temperature change in the other ring waveguide. In other words, there is a problem that the ring waveguides 3a and 3b thermally interfere with each other.

It is possible to prevent the mechanical strength from decreasing and prevent the thermal interference from occurring by reducing the length of the heater 5 as shown in the drawing. However, the lengths of the parts of the ring waveguides 3a and 3b that are heated are reduced, thus causing a problem that the effect of reducing the power consumption is reduced.

It is possible, by increasing the length of the straight parts of the ring waveguides 3a and 3b, to extend the heater 5a and the thermal insulation structure 6a along the straight parts disposed on the sides on which the input waveguide 2 is located. Similarly, it is possible to extend the heater 5b and the thermal insulation structure 6b along the straight parts disposed on the sides on which the output waveguide 4 is located. In this way, it is possible to increase the lengths of the parts of the ring waveguides 3 that are heated. However, the length of the circumference of the ring waveguides 3 increases. When the length of the circumference increases, there is a problem that the FSR (Free Spectral Range) decreases. When the radius of the curvature of the semicircular parts of the ring waveguides 3 is decreased while increasing the straight parts thereof, it is possible to prevent the FSR from decreasing. However, there is a problem that the loss caused by the bending increases.

As described above, regarding the ring resonator 20 according to the reference example, there is a problem that it is difficult to satisfy all the requirements for reducing the power consumption, ensuring the mechanical strength, and suppressing the thermal interference. The inventors of the present application have conceived an example embodiment based on the study described above.

### First Example Embodiment

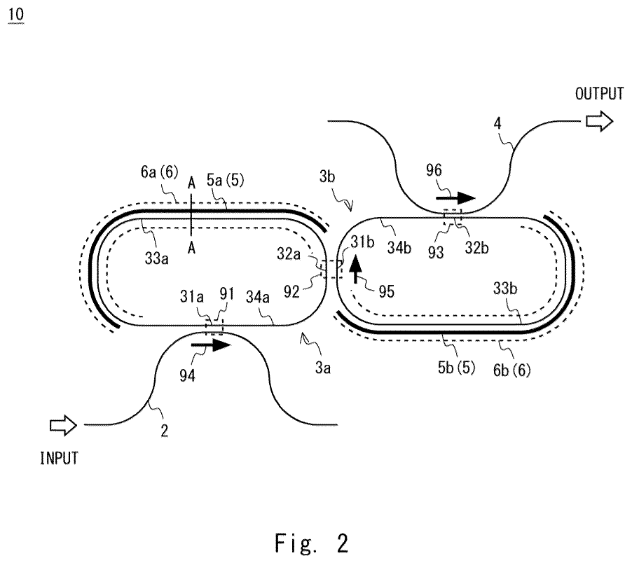

A configuration of a ring resonator 10 will be described hereinafter with reference to FIG. 2. FIG. 2 is a schematic plan view of the ring resonator 10. The ring resonator 10 includes an input waveguide 2, a ring waveguide 3a, a ring waveguide 3b, an output waveguide 4, a heater 5, and a thermal insulation structure 6. The ring waveguide 3a corresponds to a first ring waveguide. The ring waveguide 3b corresponds to a second ring waveguide. When the ring waveguides 3a and 3b are not distinguished from each other, they may be simply referred to as the ring waveguides 3.

Each of the input waveguide 2, the ring waveguide 3a, the ring waveguide 3b, and the output waveguide 4 includes a core through which light propagates. The core is surrounded, i.e., covered, by cladding. The core is formed of, for example, Si. The cladding is formed of, for example, SiO₂. The refractive index of the material of which the core is formed and that of the material of which the cladding is formed are different from each other. The ring resonator 10 may be formed on an SOI (Silicon on Insulator) substrate including a BOX (Buried OXide) layer.

The input waveguide 2 is optically connected to the ring waveguide 3a. Light is input from one end of the input waveguide 2 (e.g., the left end in the drawing). A part of the input light propagates to the ring waveguide 3a.

The ring waveguide 3a includes a waveguide part 31a, a waveguide part 32a, a waveguide part 33a, and a waveguide part 34a. The waveguide part 31a, the waveguide part 32a, and the waveguide part 33a correspond to the first waveguide part, the second waveguide part, and the third waveguide part, respectively. The waveguide part 31a is a part included in a region 91 of the ring waveguide 3a. The input waveguide 2 and the ring waveguide 3a are optically connected to each other in the region 91. The waveguide part 32a is a part included in a region 92 of the ring waveguide 3a. The ring waveguides 3a and 3b are optically connected to each other in the region 92.

The waveguide part 31a is optically connected to the input waveguide 2. The waveguide part 32a is optically connected to a waveguide part 31b of the ring waveguide 3b (which will be described later). Each of the two curved waveguide parts connects the waveguide parts 31a and 32a to each other. A curved shape means, for example, a shape expressed by a line including a continuously curved section(s). The lengths of the two waveguide parts are different from each other. The waveguide part 33a is the longer one of the two waveguide parts. The waveguide part 34a is the shorter one of the two waveguide parts. Each of the waveguide parts 33a and 34a is physically and optically connected to the waveguide parts 31a and 32a.

Light input from the waveguide part 31a circulates, i.e., propagates in a circular shape, along the ring waveguide 3a in one direction (e.g., the counterclockwise direction in the drawing). Then, light having a wavelength equal to the resonant wavelength of the ring waveguide 3a propagates from the waveguide part 32a to the ring waveguide 3b.

The ring waveguide 3b includes a waveguide part 31b, a waveguide part 32b, a waveguide part 33b, and a waveguide part 34b. The waveguide part 31b, the waveguide part 32b, and the waveguide part 33b correspond to the fourth waveguide part, the fifth waveguide part, and the sixth waveguide part, respectively. The waveguide part 31b is a part included in a region 92 of the ring waveguide 3b. The waveguide part 32b is a part included in a region 93 of the ring waveguide 3b. The ring waveguide 3b and the output waveguide 4 are optically connected to each other in the region 93.

The waveguide part 31b is optically connected to the waveguide part 32a of the ring waveguide 3a. The waveguide part 32b is optically connected to the output waveguide 4. Each of the two curved waveguide parts connects the waveguide parts 31b and 32b to each other. The lengths of the two waveguide parts are different from each other. The waveguide part 33b is the longer one of the two waveguide parts. The waveguide part 34b is the shorter one of the two waveguide parts. Each of the waveguide parts 33b and 34b is physically and optically connected to the waveguide parts 31b and 32b.

Light input from the waveguide part 31b circulates, i.e., propagates in a circular shape, along the ring waveguide 3b in one direction (e.g., the clockwise direction in the drawing). Then, light having a wavelength equal to the resonant wavelength of the ring waveguide 3b propagates from the waveguide part 32b to the output waveguide 4. The resonant wavelengths of the ring waveguides 3a and 3b may be equal to each other.

The waveguide part 31a of the ring waveguide 3a and the waveguide part 32b of the ring waveguide 3b are arranged on sides opposite to each other with respect to a center line passing through the ring waveguides 3a and 3b. The center line may pass through the centers of the ring waveguides 3a and 3b.

An arrow 94 represents the direction along the waveguide part 31a. An arrow 95 represents the direction along the waveguide parts 32a and 31b. An arrow 96 represents the direction along the waveguide part 32b. The direction along the waveguide parts 31a and 32b (also referred to as a first direction) and the direction along the waveguide parts 32a and 31b (also referred to as a second direction) are not parallel to each other. Arrows 94 and 96 represent the first direction. The arrow 95 represents the second direction. The first and second directions may be perpendicular to each other.

Each of the ring waveguides 3a and 3b has, for example, a racetrack shape. The racetrack shape consists of two parallel lines and two curves connecting the two parallel lines to each other. The two parallel lines are parallel to the first or second direction. The lengths of the two parallel lines are equal to each other. The two parallel lines shown in the drawing are parallel to the first direction. In this case, the length of the waveguide that contributes to the coupling between the ring waveguides 3a and 3b, i.e., the length of the straight-line waveguide that contributes to the coupling of the directional coupler, is relatively short. Note that each of the ring waveguides 3a and 3b may have a circular shape (e.g., a perfect-circular shape). Note that the waveguide part 31a is included in one of the two parallel lines in the ring waveguide 3a. Further, the waveguide part 32a is included in one of the two curves in the ring waveguide 3a. The waveguide part 31b is included in one of the two curves in the ring waveguide 3b. The waveguide part 32b is included in one of the two parallel lines in the ring waveguide 3b.

The output waveguide 4 is optically connected to the waveguide part 32b of the ring waveguide 3b. The output waveguide 4 outputs light from one end thereof (e.g., the right end in the drawing).

The heater 5 and the thermal insulation structure 6 are arranged along each of the waveguide part 33a of the ring waveguide 3a and the waveguide part 33b of the ring waveguide 3b. The heater 5 and the thermal insulation structure 6 arranged along the ring waveguide 3a are also referred to as a heater 5a and a thermal insulation structure 6a, respectively. The heater 5 and the thermal insulation structure 6 arranged along the ring waveguide 3b are also referred to as a heater 5b and a thermal insulation structure 6b, respectively. The heater 5 and the thermal insulation structure 6 may be arranged along each of the entire waveguide part 33a and the entire waveguide part 33b. The lengths of the parts of the ring waveguides 3 along which the heater 5 is disposed may be, for example, a half or more of the circumferences of the ring waveguides 3.

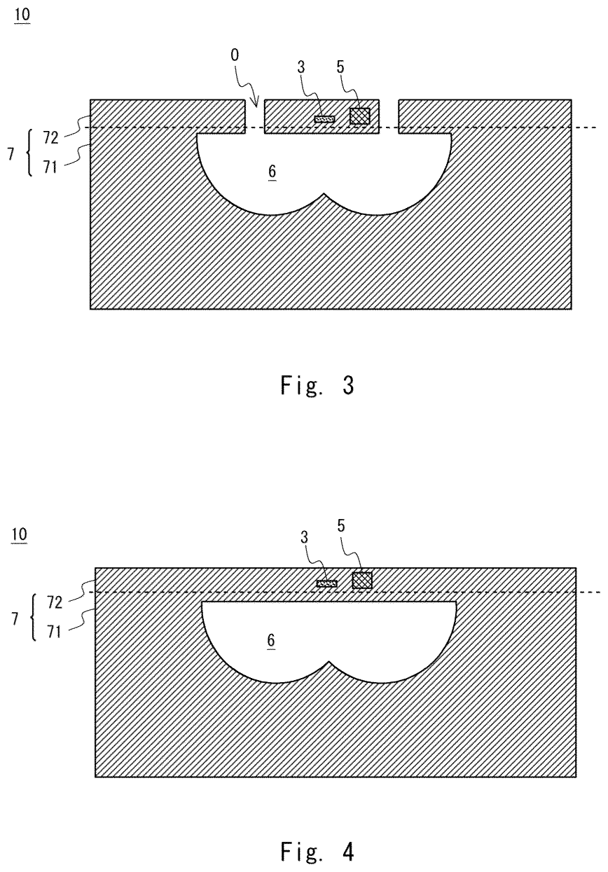

FIG. 3 schematically shows a first example of a cross-sectional view taken along a line A-A in FIG. 2. The ring resonator 10 includes a SiO₂ layer 7 formed on a substrate (not shown). The SiO₂ layer 7 may include a lower SiO₂ layer 71 disposed below the ring waveguides 3 and an upper SiO₂ layer 72 formed on the lower SiO₂ layer 71. The lower SiO₂ layer 71 may be, for example, a BOX layer of an SOI substrate. The ring waveguides 3 are formed of, for example, Si.

The heater 5 is disposed near the ring waveguides 3. Although the heater 5 is disposed on the side of the ring waveguide 3 in the drawing, the heater 5 may be disposed above or below the ring waveguides 3.

The heater 5 is formed of, for example, metal. When electric power is applied to the heater 5, the resonance wavelength of the ring waveguides 3 is shifted.

The thermal insulation structure 6 is an air layer disposed below the ring waveguides 3 in the drawing. The air layer is formed, for example, by etching the SiO₂ layer 7 disposed on both sides of the ring waveguides 3 in the depth direction, and thereby forming openings O, and then performing isotropic etching by using a reactive gas or the like. The heater 5 is positioned between the openings O and the ring waveguide 3. The thermal insulation structure 6 covers the ring waveguides 3 and the heater 5 from below.

FIG. 4 schematically shows a second example of a cross-sectional view taken along the line A-A in FIG. 1. The thermal insulation structure 6 is a vacuum layer provided below the ring waveguides 3 in the drawing. The vacuum layer may be formed, for example, before forming the upper SiO₂ layer 72, by etching the lower SiO₂ layer 71 in the depth direction and then performing isotropic etching. The upper SiO₂ layer 72 may be formed on the lower SiO₂ layer 71 after the vacuum layer is formed.

Next, effects of the present disclosure will be described with reference to FIG. 2. The heater 5 and the thermal insulation structure 6 are arranged in a point symmetry with respect to the center of the region 92. A sufficient distance is secured between the region where the heater 5a and the thermal insulation structure 6a are arranged and the region where the heater 5b and the thermal insulation structure 6b are arranged. As a result, it is possible to prevent the mechanical strength from decreasing and prevent the thermal interference from occurring. Further, since sufficient lengths of the heater 5a and the thermal insulation structure 6a can be secured, the power consumption of the heater 5 can be reduced. Since the length of the circumferences of the ring waveguides 3a and 3b is not increased, narrow-bandwidth filtering characteristics are achieved.

### Second Example Embodiment

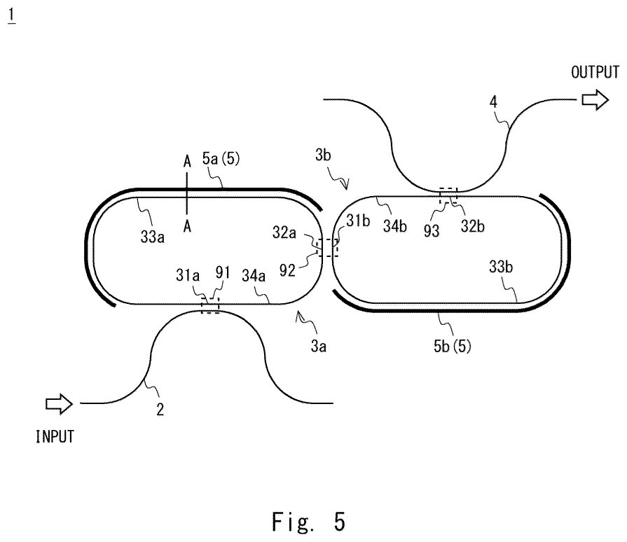

The configuration of the ring resonator 1 will be described with reference to FIG. 5. As can be seen from the comparison between FIGS. 2 and 5, the ring resonator 1 may not include the thermal insulation structure 6. The material of which each waveguide is formed is not limited to Si, but may be any material with which light can be guided. One or a plurality of ring waveguides may be arranged between the ring waveguides 3a and 3b.

In the ring resonator 1, it is possible to prevent the thermal interference from occurring while securing the lengths of the parts of the ring waveguides 3 that are heated by the heater 5.

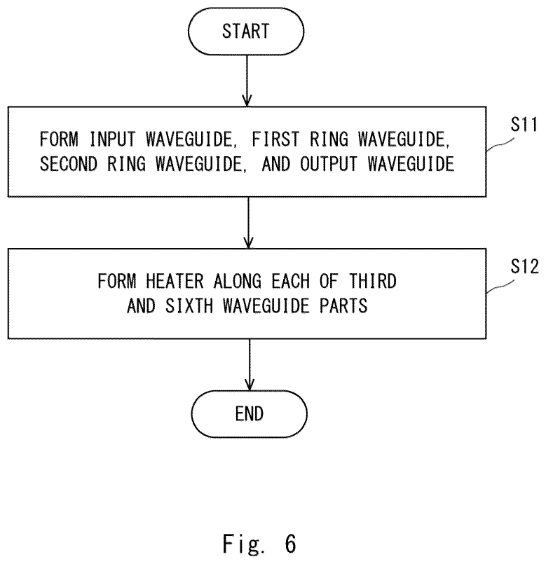

A method for manufacturing a ring resonator 1 will be described with reference to FIG. 6. In a step S11, an input waveguide 2, a ring waveguide 3a (first ring waveguide), a ring waveguide 3b (second ring waveguide), and an output waveguide 4 are formed. Each of the input waveguide 2, the ring waveguide 3a, the ring waveguide 3b, and the output waveguide 4 is formed, for example, by forming a resist pattern by lithography and etching an SOI substrate by using the formed resist as a photomask. An upper SiO₂ layer 72 may be formed after etching the SOI substrate.

In a step S12, a heater 5 is formed along each of the waveguide part 33a of the ring waveguide 3a (third waveguide part) and the waveguide part 33b of the ring waveguide 3b (sixth waveguide part). The heater 5 may be formed, for example, by forming a resist pattern by lithography, and then forming a metal film and peeling the formed resist. Note that the heater 5 may be formed by etching the metal film after forming the metal film.

The order of the steps S11 and S12 may be reversed. Further, the method for manufacturing a ring resonator 1 may include forming a thermal insulation structure 6 along the waveguide parts 33a and 33b. The formation of the thermal insulation structure 6 may include, for example, forming an opening(s) in the SiO₂ layer by using a resist or the like as a photomask and performing isotropic etching after forming the opening(s).

By the manufacturing method shown in FIG. 6, it is possible to manufacture a ring resonator in which thermal interference is prevented from occurring while the length of a part of a ring waveguide that is heated by a heater is secured.

Although the present disclosure is described above with reference to example embodiments, the present disclosure is not limited to the above-described example embodiments. Various modifications that can be understood by those skilled in the art can be made to the configuration and details of the present disclosure within the scope of the disclosure. Further, the example embodiments may be combined with one another as appropriate.

Each of the drawings is merely an example for explaining one or more example embodiments. Each of the drawings is not associated with only one particular example embodiment, but may be associated with one or more other example embodiments. As will be appreciated by those skilled in the art, various features or steps described with reference to any one of the drawings may be combined with features or steps shown in one or more other figures to, for example, create an example embodiment that is not explicitly shown or described in the present disclosure. Not all of the features or steps shown in any one of the drawings are required to explain an example embodiment, and some of the features or steps may be omitted. The order of the steps described in any one of the drawings may be changed as appropriate.

The whole or part of the example embodiments disclosed above can be described as, but not limited to, the following supplementary notes.

### (Supplementary Note 1)

A ring resonator comprising:
an input waveguide;
a first ring waveguide;
a second ring waveguide;
an output waveguide; and
a heater, wherein
the first ring waveguide comprises a first waveguide part optically connected to the input waveguide, a second waveguide part optically connected to the second ring waveguide, and two curved waveguide parts each connecting the first and second waveguide parts to each other,
lengths of the two waveguide parts of the first ring waveguide are different from each other,
the second ring waveguide comprises a fourth waveguide part optically connected to the second waveguide part, a fifth waveguide part optically connected to the output waveguide, and two curved waveguide parts each connecting the fourth and fifth waveguide parts to each other,
lengths of the two waveguide parts of the second ring waveguide are different from each other,
the first and fifth waveguide parts are arranged on sides opposite to each other with respect to a center line passing through the first and second ring waveguides,
a first direction along the first and fifth waveguide parts and a second direction along the second and fourth waveguide parts are not parallel to each other, and
the heater is disposed along each of a third waveguide part and a sixth waveguide part, the third waveguide part being a longer one of the two waveguide parts of the first ring waveguide, and the sixth waveguide part being a longer one of the two waveguide parts of the second ring waveguide.

### (Supplementary Note 2)

The ring resonator described in Supplementary note 1, wherein the first and second directions are perpendicular to each other.

### (Supplementary Note 3)

The ring resonator described in Supplementary note 1 or 2, further comprising a thermal insulation structure disposed along each of the third and sixth waveguide parts.

### (Supplementary Note 4)

The ring resonator described in Supplementary note 3 wherein the thermal insulation structure covers the first and second ring waveguides and the heater from below.

### (Supplementary Note 5)

The ring resonator described in Supplementary note 4, wherein each of the first and second ring waveguides comprises a core formed of Si.

### (Supplementary Note 6)

The ring resonator described in Supplementary note 2, wherein
each of the first and second ring waveguides comprises two parallel lines and two curves connecting the two parallel lines to each other,
the two parallel lines are parallel to the first or second direction, and
lengths of the two parallel lines are equal to each other.

### (Supplementary Note 7)

The ring resonator described in Supplementary note 6, wherein
the first waveguide part is included in one of the two parallel lines in the first ring waveguide,
the second waveguide part is included in one of the two curves in the first ring waveguide,
the fourth waveguide part is included in one of the two curves in the second ring waveguide, and
the fifth waveguide part is included in one of the two parallel lines in the second ring waveguide.

### (Supplementary Note 8)

The ring resonator described in Supplementary note 2, wherein heaters are arranged in a point symmetry with respect to a center of a region where the first and second ring waveguides are optically connected to each other.

### (Supplementary Note 9)

The ring resonator described in Supplementary note 1 or 2, wherein the heater is disposed along each of the entire third waveguide part and the entire sixth waveguide part.

### (Supplementary Note 10)

A method for manufacturing a ring resonator, comprising:
forming an input waveguide, a first ring waveguide, a second ring waveguide, and an output waveguide; and
forming a heater, wherein
the first ring waveguide comprises a first waveguide part optically connected to the input waveguide, a second waveguide part optically connected to the second ring waveguide, and two curved waveguide parts each connecting the first and second waveguide parts to each other,
lengths of the two waveguide parts of the first ring waveguide are different from each other,
the second ring waveguide comprises a fourth waveguide part optically connected to the second waveguide part, a fifth waveguide part optically connected to the output waveguide, and two curved waveguide parts each connecting the fourth and fifth waveguide parts to each other,
lengths of the two waveguide parts of the second ring waveguide are different from each other,
the first and fifth waveguide parts are arranged on sides opposite to each other with respect to a center line passing through the first and second ring waveguides,
a first direction along the first and fifth waveguide parts and a second direction along the second and fourth waveguide parts are not parallel to each other, and
the heater is disposed along each of a third waveguide part and a sixth waveguide part, the third waveguide part being a longer one of the two waveguide parts of the first ring waveguide, and the sixth waveguide part being a longer one of the two waveguide parts of the second ring waveguide.

Some or all of the elements (e.g., configuration and function) described in Supplementary notes 2 to 9 that are dependent on Supplementary notes 1 may be dependent on Supplementary notes 10 by the same dependency as Supplementary notes 2 to 9.

Some or all of the elements described in any appendices may be applied to various hardware, software, recording means, systems, and methods for recording software.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. A ring resonator comprising:
an input waveguide;
a first ring waveguide;
a second ring waveguide;
an output waveguide; and
a heater, wherein
the first ring waveguide comprises a first waveguide part optically connected to the input waveguide, a second waveguide part optically connected to the second ring waveguide, and two curved waveguide parts each connecting the first and second waveguide parts to each other,
lengths of the two waveguide parts of the first ring waveguide are different from each other,
the second ring waveguide comprises a fourth waveguide part optically connected to the second waveguide part, a fifth waveguide part optically connected to the output waveguide, and two curved waveguide parts each connecting the fourth and fifth waveguide parts to each other,
lengths of the two waveguide parts of the second ring waveguide are different from each other,
the first and fifth waveguide parts are arranged on sides opposite to each other with respect to a center line passing through the first and second ring waveguides,
a first direction along the first and fifth waveguide parts and a second direction along the second and fourth waveguide parts are not parallel to each other, and
the heater is disposed along each of a third waveguide part and a sixth waveguide part, the third waveguide part being a longer one of the two waveguide parts of the first ring waveguide, and the sixth waveguide part being a longer one of the two waveguide parts of the second ring waveguide.

2. The ring resonator according to claim 1, wherein the first and second directions are perpendicular to each other.

3. The ring resonator according to claim 1, further comprising a thermal insulation structure disposed along each of the third and sixth waveguide parts.

4. The ring resonator according to claim 3 wherein the thermal insulation structure covers the first and second ring waveguides and the heater from below.

5. The ring resonator according to claim 4, wherein each of the first and second ring waveguides comprises a core formed of Si.

6. The ring resonator according to claim 2, wherein
each of the first and second ring waveguides comprises two parallel lines and two curves connecting the two parallel lines to each other,
the two parallel lines are parallel to the first or second direction, and
lengths of the two parallel lines are equal to each other.

7. The ring resonator according to claim 6, wherein
the first waveguide part is included in one of the two parallel lines in the first ring waveguide,
the second waveguide part is included in one of the two curves in the first ring waveguide,
the fourth waveguide part is included in one of the two curves in the second ring waveguide, and
the fifth waveguide part is included in one of the two parallel lines in the second ring waveguide.

8. The ring resonator according to claim 2, wherein heaters are arranged in a point symmetry with respect to a center of a region where the first and second ring waveguides are optically connected to each other.

9. The ring resonator according to claim 1, wherein the heater is disposed along each of the entire third waveguide part and the entire sixth waveguide part.

10. A method for manufacturing a ring resonator, comprising:
forming an input waveguide, a first ring waveguide, a second ring waveguide, and an output waveguide; and
forming a heater, wherein
the first ring waveguide comprises a first waveguide part optically connected to the input waveguide, a second waveguide part optically connected to the second ring waveguide, and two curved waveguide parts each connecting the first and second waveguide parts to each other,
lengths of the two waveguide parts of the first ring waveguide are different from each other,
the second ring waveguide comprises a fourth waveguide part optically connected to the second waveguide part, a fifth waveguide part optically connected to the output waveguide, and two curved waveguide parts each connecting the fourth and fifth waveguide parts to each other,
lengths of the two waveguide parts of the second ring waveguide are different from each other,
the first and fifth waveguide parts are arranged on sides opposite to each other with respect to a center line passing through the first and second ring waveguides,
a first direction along the first and fifth waveguide parts and a second direction along the second and fourth waveguide parts are not parallel to each other, and
the heater is disposed along each of a third waveguide part and a sixth waveguide part, the third waveguide part being a longer one of the two waveguide parts of the first ring waveguide, and the sixth waveguide part being a longer one of the two waveguide parts of the second ring waveguide.
